(19) United States
(12) Patent Application Publication
(10) Pub. No.: US 2015/0369414 A1
(43) Pub. Date: Dec. 24, 2015

(54) PREFABRICATED HEATABLE MEDIA LINE, USE OF SUCH A MEDIA LINE, AND METHOD FOR PRODUCING SAME

(71) Applicant: VOSS AUTOMOTIVE GMBH, Wipperfürth (DE)

(72) Inventor: Otfried SCHWARZKOPF, Kürten (DE)

(21) Appl. No.: 14/761,334

(22) PCT Filed: Jan. 14, 2014
(86) PCT No.: PCT/EP2014/000060

§ 371 Date: Jul. 16, 2015

(30) Foreign Application Priority Data
Jan. 16, 2013 (DE) 10 2013 000 588.4

(51) Int. Cl. F16L 53/00; H05B 3/06; F24H 1/10

(52) U.S. Cl. CPC F16L 53/008; F24H 1/102; H05B 3/06

(57) ABSTRACT

A prefabricated heatable media line having a media line with two connection ends, having at least one line connector which is connected to one of the connection ends of the media line, and having an electric heating element paired with the media line. A single heating element which is paired with the media line is arranged and/or formed over the longitudinal extension of the prefabricated heatable media line such that a heat input (Q1, Q2) into the media line is produced, the heat input being differentiated over the longitudinal extension of the prefabricated heatable media line, and at least two differently heated or heatable sections are produced or can be produced along the prefabricated heatable media line. When using such a prefabricated heatable media line, wherein at least one section of the prefabricated heatable media line arranged in a surrounding area which is heated or can be heated or is protected from the cold and at least one section is arranged in a surrounding area which is comparatively colder, the heating element is arranged along the heatable media line such that the at least one heatable media line section arranged in the surrounding area which is heated, can be heated, or is protected from the cold is not heated to a high degree or is heated or can be heated to a lesser degree than the at least one other medial line section. In a method for producing a heatable media line, the heatable media line is wound together with the heating element in a discontinuous manner over the longitudinal extension of the media line.

### FIELD OF THE INVENTION

The invention relates to a prefabricated heatable media line comprising at least one media line with two connection ends, at least one line connector which is connected to one of the connection ends of the media line, and comprising an electric heating element paired with the media line, a method for producing such a heatable media line, the use thereof, wherein one section of the prefabricated heatable media line is arranged in a surrounding area that is heatable or heated or protected from the cold, in particular close to a heat source, and at least one section is arranged in a surrounding area that is comparatively cooler, and a vehicle, particularly a land vehicle, equipped with at least one heatable media line, wherein at least one section of the heatable media line is arranged in a region of the vehicle that is heatable or heated or protected from the cold, in particular close to a heat source, and at least one section is arranged in a region of the vehicle that is comparatively cooler.

### BACKGROUND OF THE INVENTION

Prefabricated heatable media lines and methods for production thereof are known in the prior art. They are provided particularly in vehicles for transporting liquid media. At low temperatures, there is a risk that the media lines may freeze, and for this reason a heating means is provided. Line connectors which are arranged on the ends of the media line connection ends serve to connect at least two media lines or as a terminal connection between a media line and some other unit type. The media lines often carry media that have a relatively high freezing point and consequently tend to freeze even at quite high ambient temperatures, and may thus for example impair the capabilities or even significantly interfere with the function of a vehicle. This evidently happens particularly with water lines for windscreen washing systems, as well as for media lines for transporting aqueous urea solution as a medium used as a NOₓ-reaction additive in diesel engines equipped with “SCR catalytic converters”.

The heating elements serve to heat the media line and/or the line connectors. For this purpose, they are arranged on the inside and/or the outside of the media line and the line connectors. The heating elements may be connected in series and connected to a common power source. It is also known to connect individual heating elements to one another singly in parallel. It is further known to provide multiple heating elements along the longitudinal extension of the of the prefabricated heatable media line, particularly heating elements that only extend along the media line and heating elements that are coiled around the line connectors, wherein the respective heating elements are connected or crimped together with each other. In order to be able to connect the heating elements to an electric power supply, electric supply leads may be provided, which are also connected to the heating elements most often by means of crimp connections. In order to protect the various crimp connections between the heating elements themselves and between the heating elements and the electric supply leads from damage, the connections are typically enclosed in an outer mantle, such as a shrink-on tube, shrink-wrap adhesive tape, overmoulding with plastic or in an encapsulation of the prefabricated heatable media line.

Precisely when the prefabricated heatable media line is used in a vehicle, the heat requirement over the longitudinal extension of the heatable media line varies according to whether the routing of the line takes it close to a heat source, such as an engine or the exhaust system, or a relatively cooler area such, for example close to the fuel tank, with the result that the medium that is transportable or transported via the heatable media line is at risk of freezing at low temperatures. The medium that passes or is able to pass through the heatable media line in the section thereof that is close to a heat source, such as an engine, may thaw again more quickly without assistance after freezing when the vehicle is stationary than the medium in the section of the heatable media line that is close to the fuel tank, for example. Close to the heat source, the heatable media line is briefly exposed to temperatures as high as 140° to 180° C., for example, and occasionally even in the region of 200° C., so it is typically not at risk of freezing while the vehicle is travelling. An additional device to aid with thawing would probably not be required.

It is already known from DE 10 2010 053 737 A1 to create a heatable media line that is resistant to heat, pressure and freezing by providing a heatable media line in which the pipeline includes at least two long sections that are designed differently in terms of their material properties and/or structural form, and consisting on the one hand of at least a first long section made from a first material containing a first polymer, and on the other hand a second long section made from a second material containing a second polymer, wherein the material of the second long section is more flexible and/or can sustain greater stresses than the material of the first long section.

However, the heatable media line can still be damaged in the proximity of a heat source if it is heated excessively, particularly in the area of the connection or crimping points of the heating elements. Moreover, the materials used to make the components of the heatable media line that are arranged close to a heat source must be capable of withstanding high temperatures, so expensive materials must be used here.

### SUMMARY OF THE INVENTION

The object underlying the present invention is therefore to develop a prefabricated heatable media line comprising: at least one media line with two connection ends, at least one line connector, which is connected to one of the connection ends of the media line, and comprising an electric heating element paired with the media line, appropriately for the respective application or use case, it is possible to ensure that the heatable media line is protected effectively from overheating and thus also damage.

This object is solved for a prefabricated heatable media line comprising: at least one media line with two connection ends, at least one line connector, which is connected to one of the connection ends of the media line, and comprising an electric heating element paired with the media line wherein in that a single electric heating element is paired with the media line, and is arranged and/or formed over the longitudinal extension of the prefabricated heatable media line, such that a heat input into the media line is produced, said heat input being differentiated over the longitudinal extension of the prefabricated heatable media line, wherein at least two differently heatable or heated sections may be or are created along the length of the prefabricated heatable media line. Regarding the use of such a prefabricated heatable media line wherein at least one section of the prefabricated heatable media line is arranged in a surrounding area that is heatable or heated or protected against the cold, and at least one section is arranged in a relatively colder surrounding area, the object is solved in that the heating element is arranged along the heatable media line in such manner that the at least one section of the heated media line arranged in the region that is heatable, heated, or protected from the cold is not heatable or heated, or heatable or heated to a lesser degree than the at least one other section thereof. For a vehicle, particularly a land vehicle, wherein at least one section of the heatable media line is arranged in an area of the vehicle that is heatable or heated or protected against the cold, and at least one section is arranged in an area of the vehicle that is relatively cooler, the object is solved in that the media line is equipped with only a single heating element, and the heating element is arranged along the heatable media line in such manner that the at least one section of the media line arranged in the area of the vehicle that is heatable, heated or protected from the cold is not heatable or heated, or heatable or heated to a lesser degree than the at least one other section thereof. Regarding a method for producing a heatable media line, the object is solved in that the heatable media line is wound with a single heating element discontinuously over the longitudinal extension thereof. Further developments of the invention are defined in the dependent claims.

In this way, a prefabricated heatable media line is created that is furnished with only a single heating element, which extends along at least a section of the media line with the result that a section that is heatable by the heating element and a section that is not heatable thereby is created along the heatable media line, that is to say one section with low heat input and one section with higher heat input into the heatable media line. A system boundary may be defined correspondingly between the two sections of differing heat supply or heat input. In the following, the term media line is understood to refer to a media line having the form of a pipe and/or hose, that is to say a line in which a medium is able to flow through the at least one interior cavity thereof. The media line may also be constructed as a multilayer pipe or hose. In the following, the term prefabricated heatable media line, also abbreviated to heatable media line, is used to describe the media line furnished with at least one line connector, wherein at least one section of the media line is furnished with the heating element to provide heatability. For the purpose of the prevent invention, a heating element is a means for introducing heat, that is to say for heating the heatable media line. In particular, the term heating element is understood to refer to heat conductors, heating flexes, heating strips and heating wires, wherein a heat conductor is understood to be a heat conducting element that causes heat to be transferred to the line wall. The term heating element is also understood to refer to a heating coil, itself comprising an inner fibre and wires wound around said inner fibre. The heating element may be provided with or without external insulation, that is to say in particular also in the form of uninsulated heater wires or resistance wires. Various sections with different heat input may be provided both along the media line and along the entire prefabricated heatable media line, that is to say along the media line and the at least one line connector arranged at the end thereof or both line connectors arranged at the two ends thereof. In this way, a number n of system boundaries where n≧1 are created between the individual sections. In an area surrounding the installation site of the prefabricated heatable media line, particularly in the area of a vehicle in which sufficient heating is available anyway, for example by a running vehicle engine or the exhaust system, it may thus be advantageous for no additional heating means or only low heating means to be provided for the heatable media line in the correspondingly located section of the media line, but on the other hand to provide a particularly strongly or at least readily heatable section of the heatable media line in a relatively cooler area, particularly of a vehicle.

By using only one heating element, which extends over all of the sections of the heatable media line that are to be heated thereby, it is advantageously possible to dispense with connecting or crimping points between multiple heating elements, which are expensive and vulnerable to damage from the effects of heat or possibly even mechanical influences or extremely low temperatures, particularly in the very hot regions, where it is then no longer necessary to implement special solutions for withstanding particularly high temperatures, which are correspondingly costly. It is not usually possible to use standard crimped or shrink-on hose connections in high temperature areas. Instead, fluoropolymers must be used, but these provide poor connection because of a phenomenon known as the “Teflon® effect”, with the result that in the prior art the heating means can fail in one or more sections of the heatable media line arranged in the high temperature region, and special solutions are needed to ensure that these heating elements can also be connected. Failure of the heating means may thus be avoided by not implementing connecting or crimping points along the heating element, particularly in the one or more hot or high temperature region(s), that is to say by using only a single heating element that extends over the entire heatable media line. Otherwise, connection points can cause the heating means to fail during operation of a heatable media line, and it is therefore highly advantageous to avoid the need for connection points, since they can also not overheat when heat is applied, which can otherwise result not only in damage to the connecting or crimping points and/or the heating element and/or the heating means, but may even damage the wall of the media line itself. Consequently, this is effectively prevented by the provision of only a single heating element. This is also advantageously prevented by the fact that the heating element is arrange on the media line outside of the hot region, that is to say at least at a small distance therefrom, and damage may thus be avoided by the mere provision of a spatial removal of the heating element from the hot region.

The at least two differently heatable sections are advantageously provided along the media line and/or along the line connection and/or along the transition zone from the media line to one of the line connectors. The media line may particularly comprise at least a first section that is heatable by the heating element and the line connector may comprise at least a second section that is not heated at all or not heatable as strongly as the first section by the heating element. Particularly the line connector, and possibly also the transition zone from the media line to the line connector that is arranged in a surrounding area that is particularly warm or protected from the effect of cold, or a particularly warm area of the vehicle, such as the region of the vehicle engine, is accordingly designed so as not to be heatable at all or less strongly heatable or warmable than the remaining part of the media line. This remaining part of the media line and possibly a further line connector arranged on the end thereof may be designed to be able to withstand stronger warming effects, although here too differences in terms of the possible heat input may be introduced over the longitudinal extension of the heatable media line by varying the arrangement or construction of the heating element, for example by configuring the heating element with a different pitch.

It is particularly advantageous to provide a discontinuous winding in the longitudinal extension of the heatable media line and over the entire length thereof, with a continuous pitch of the heating element within a heatable section. In this context, a discontinuous winding means a winding having a variable pitch in the same coil. This makes it possible provide a heat input that is different for each section over of the longitudinal extension of the heatable media line. Individual sections to which an even heat input is to be applied may be provided with a continuous pitch in the coil winding with the heating element.

Such a discontinuous winding, that is to say a geometrical variance of the heating element arrangement, may be provided in order to create a differentiated heat input over the longitudinal extension of the heatable media line. The provision of a discontinuous winding enables a highly individual winding to be produced, which is adapted precisely to the requirements of the respective installation site. At the same time, the heating power that the heating element can put out may also be varied, for example by varying the diameter thereof over the longitudinal extension of the heatable media line. It is also possible to design the heating element with a PTC effect, so that the element is warmed to different degrees by the ambient temperature, as a result of which it is also possible to introduce different levels of heat into the prefabricated heatable media line. PTC stands for the positive temperature coefficient, usually of a resistor, in other words a decrease and increase in resistance at a specific temperature or within a small temperature range. PTC resistors are electrically conductive materials that can conduct current better at lower temperatures than at high temperatures. Their electric resistance increases as the temperature rises. Resistors of this kind thus have a positive temperature coefficient. The area of the heatable media line that is equipped with the heating element with PTC resistor is the hot area of the heatable media line, that is to say the area that is located in the vicinity of a vehicle engine or close to the exhaust system in a vehicle in the direction of a metering point of an injection device. Particularly the area close to a fuel tank of the vehicle may be described as a cold area, in which correspondingly a higher power coupling or greater heat input is provided to heat the medium as it flows in that direction. In the hot or warmer area, or the hot area of the heatable media line, the radiated heat existing there is already sufficient to warm the medium as it flows through the heatable media line, that is to way particularly to thaw the medium when ambient temperatures outside the vehicle are low.

At least one sheath system may be provided, surrounding the prefabricated heatable media line and enabling air to circulate in the intermediate space between the outside of the heatable media line and the inside of the sheath system to exchange heat between at least one heatable or warm section of the heatable media line and at least one relative colder section thereof. The heating element is not required for heating in the hot region, since air that has been warmed in the hot region of the heatable media line is able to circulate inside the insulating sheath system of the heatable media line and reach colder sections of the heatable media line, thus ensuring that not only the medium flowing in the hot region but also the medium flowing in the adjacent sections of the heatable media line can be warmed, and consequently that the heat input by the heating element may be reduced. It may be sufficient to place a less powerful heating element there. Powerful additional warming of the medium flowing through the media line and the line connectors may also not be necessary in a section which, although not close to a heat source, is in a position that is protected from cold, in a section of the heatable media line in which the medium flowing through the section is rarely or never at risk of freezing because of the protected positioning of the section.

Conversely, in places where it is only heated weakly or not at all by the heating element, the heatable media line may be exposed to weak secondary heating in sections by its enclosure with the sheath system due to the circulation of air that has been warmed din the heated sections. This may prove advantageous when, for example, during or before startup of a vehicle, neither the exhaust system nor the engine is giving off heat that can cause the medium flowing through this section of the prefabricated heatable media line to warm up. When the one or more other section(s) of the heatable media line is (are) heated with the assistance of the heating element, the section of the heatable media line located close to a heat source may also undergo weak secondary heating due to air circulation until the radiated heat or heat input from the heat source takes effect, that is to way particularly from the exhaust system or the vehicle engine.

As indicated earlier, a variation in the heat input, that is to say heating power that is not constant over the longitudinal extension of the heatable media line per unit of length of the heatable media line, may be achieved by varying the pitch of the winding of the media line and/or of the at least one line connector, but also geometrical shapes when placing the heating element on the media line and/or the one or more line connectors. The number or geometry of the strands in the heating element may also be varied over the longitudinal extension thereof, thus enabling the power coupling with the heatable media line to be varied due to a variation in said coupling over the longitudinal extension of the heatable media line. Different heat couplings or heat inputs in sections of the media line and the at least one line connector or the medium flowing through it (them) are also provided by varying the position of the fastening devices used to fasten the heating element on the outside of the media line and the line connector. The fastening device may be for example a tape fastener, but fastening devices may also be in the form of clips or rings. Selective winding of the media line with the heating element may also be provided. Selective winding means the provision of a specifiable or defined discontinuous winding of the media line with the heating element, adapted to the respective requirements of the individual application with reference to the arrangement and quantity of the heating element. The heating element is placed precisely at the points where heat input to the media line and the one or more line connectors is desired or necessary. In the case of selective winding of the media line and the at least one line connector with the heating element, the media line wall does not need to be as thick, so that in this respect a smaller amount of material is required for the heating element and than media line than in other typical designs of a media line. Winding may be carried out on the outside of a single layer or multilayer media line, but also on an inner layer, which is then covered with one or more layers of a multilayer media line.

It has proven particularly advantageous to provide at least one section of the heatable media line without heat input from the electric heating element, in particular to provide a line connector of the heatable media line not wound with the heating element, particularly preferably a line connector and a section of the media line not wound with the heating element. This line connector is located in the hot region, thus in particular close to the vehicle exhaust system or the engine, or generally in the area of a heat source and/or in an area that is protected from cold. The line connector positioned close to the heat source of the heatable media line is thus advantageously not furnished with the heating element. A part of the media line that is connected to the line connector may also be constructed without the heating element. Then no heat input from the electric heating element is supplied to this section of the media line either. Additional heating by means of the heating element is not necessary in the hot region. Since no electric components are present, of the heating element for example, the risk of failure thereof in the hot region and the need to implement heat-resistant special solutions in the hot region, which are expensive and may still fail themselves, may be avoided. One potential cause of failure for the electric components may thus be eliminated by the absence of a heating means in the section(s) of the heatable media line located in the hot region.

The heating element is advantageously configured to form at least one loop having one closed end and two open ends, and is arranged with its closed end outside the line connector on the media line that is not be heated by the heating element. When a heating element loop is arranged with the closed end of the loop facing the line connector that is not to be heated by the heating element, the use of connecting or crimping points to connect the line connector with electric supply leads for connection to a power supply for example, may be dispensed with there. The unheated line connector may therefore be arranged close to a heat source such as an engine or exhaust system without running the risk that connecting or crimping points might be damaged by the heat. In this way, it is possible to effectively prevent another otherwise common cause of failure of the heating means for a heatable media line due to crimping points damaged by heat, which would otherwise have to be made from very highly heat resistant materials in order to withstand the thermal effects, wherein in order to preserve their connecting capabilities, as stated previously, compromises would have to be made between heat resistance and the capability of ensuring a reliable connection despite the properties of the heat-resistant materials, which actually tend to militate against the maintenance of connections.

The closed end of the heating element is advantageously fastened to the media line by at least one fastening device, particularly a clip and/or a bonding element and/or an adhesive or fabric tape or duct tape and/or a hooked fastening element. If such a fastening device is used, it is possible to fix the closed end of the heating element permanently in the predetermined position, so that the desired heat input distribution may be preserved over the entire longitudinal extension of the prefabricated heatable media line even when the prefabricated heatable media line is in operation. The choice of fastening device may be made on the basis of the case in question, and also particularly according to the available installation space.

Advantageously, when two line connectors are arranged at the ends of the media line, the heatable line connection provided with only one of the two heating element end sections is wound in particular. The heating element loop is advantageously positioned in such manner that the two open heating element ends are arranged asymmetrically with respect to each other, that is to say with a lengthwise offset, so that one of the heating element ends may be used for winding around the heatable line connector and the other is connected directly an electric supply lead or an electric plug, for example, to ensure a connection with the electric power supply. It is therefore very advantageous to arrange only one heating element end on or at the line connector, which makes it simpler to provide the line connector with the heating element.

In general, using an additional heating element for the one heatable line connector is not inconsistent with the present invention. However, this then only extends over the heatable line connector, and in this area is electrically connected in series or in parallel, particularly crimped, to the other heating element, which otherwise extends along the media line and possibly along a part of the other line connector.

Ends of the heating element that have been or are to be equipped with electric supply leads are advantageously arranged at a distance from the heatable or heated region of the vehicle, or are advantageously arranged at a distance from the line connector without a heating element winding. The effect of this is that crimp connections between the heating element and the electric supply leads are not exposed to the occasionally considerably heat in the proximity of the vehicle's exhaust system or engine, but are rather arranged remotely from these heat sources either along the tubular or hose-like media line or in the arear of the least one further line connector, which is advantageously located in the cold zone or in an area that is cooler than the area of the vehicle which is warmer or warmed by an external heat source. Even when the heating element is connected directly to an electric plug for connection to a power source, that is to say when the electric supply leads are omitted, such an electric plug is preferably arranged at a distance from a heat source on the vehicle or in the area surrounding the vehicle, to avoid damaging the plug in particular due to exposure to excessive heat.

It is also advantageous if the length of the prefabricated heatable media line section that receives no heat input from the heating element is shorter than the length of he the prefabricated heatable media line that is furnished with the heating element. The length of the section with no heat input may particularly be less than 20% as long as the total length of the heatable media line. If multiple media lines are connected consecutively, the length of the section without heat input relative to the heating element may be for example less than 5 to 10% of the total length of the heatable media line.

The prefabricated heatable media line may comprise multiple media lines or multiple media line sections connected consecutively in series, which are connected to each other electrically and/or fluidically via line connectors or other connecting devices. Over the total longitudinal extension of the prefabricated heatable media line, which then comprises multiple media lines or media line sections and particularly also multiple line connectors or connecting devices for the media line sections, various heat inputs may be created according to the specific implementation circumstances by providing or omitting the heating element, varying the positioning and pairing thereof with the media line sections or media lines, or the design of the heating element over its longitudinal extension and/or cross section, or by providing multiple heating elements along further media lines that are connected to the first media line.

If multiple consecutively connected media lines are provided, the at least one heating element of the at least one further media line may be connect in series with the heating element of the first media line. In addition, one or even more of the heating elements may be connectible or connected to an electric voltage supply, particularly via two electric supply leads arranged on the end of the heating element. In this context too, a connection to the electric voltage supply is advantageously arranged remotely from the line connector with which very little or none of the heating element is wound and a section of the first media line of the prefabricated heatable media line with which very little or none of the heating element is wound, wherein the line connector and the section is or may be provided in a hot region of a vehicle or a region thereof that is protected from the effects of cold, or generally in an environment in which the prefabricated heatable media line is arranged. A second media line connected electrically with the first media line may also be furnished with only one heating element, in which case a connection is provided to an electric voltage supply close to the electric connection between the two heating elements, each of which extends along both media lines.

In principle it is even possible to arrange a continuous heating element along multiple interconnected media line sections. In this case, the heating element would be arranged after the individual media lines or media line sections had been coupled to each other, or at least there would be enough heating element length left over after the arrangement of the heating element on the first media line and optionally on a second line connector, which is connected to a first line connector of a second media line, to enable it to be arranged along the second media line and along at least one line connector that is heatable by the heating element.

Multiple consecutively connected media lines may also be provided, for reasons of cost, for example. In this context, the media line segments may be of different lengths. In particular, the media line segment arranged in the hot region, particularly in the proximity of an external heat source, such as an exhaust system or vehicle engine, may be shorter than the one or more further media line segments, in order to reduce costs. The media line segment arranged in the hot region advantageously consists of a heat-resistant material, and is correspondingly more expensive, and it is therefore preferable here if only the segment of the heatable media line that is actually exposed to high temperatures is made from such an expensive material, whereas the rest of the heatable media line is made from a less expensive material, which however is then usually less resistant to heat. A suitable material for the media line is a material with good resistance to high temperatures, particularly a heat-resistant plastic such as a polymer, particularly a high-performance polymer.

The media line in the hot region may be made from a heat-resistant elastomer, for example, such as ethylene propylene diene monomer (EPDM) for a thermal load up to 170° C., hydrated nitrile rubber (HNBR), ethylene propylene monomer (EPM) for a thermal load above 200° C., or a thermoplastic elastomer (TPE).

Most particularly, fluoropolymers such as polytetrafluoroethylene (PTFE), ethylene tetrafluoroethylene (ETFE), fluorinated ethylene propylene (FEP), polyarylene ether ketones (PEAK), polyphenylenes such as poly[di-(oxy-1,4-phenylene)carbonyl-1,4-phenylene] (polyether ether ketone, PEEK), poly[oxy-1,4-phenylene oxy-di-(1,4-phenylene-carbonyl-1,4-phenylene] (polyether ether ketone, PEEKK) or poly[oxy-1,4-phenylene carbonyl-1,4-phenyleneoxy-di-(1,4-phenylene carbonyl)-1,4-phenylene] (polyether ketone ether ketone, PEKEKK), or also polyarylene sulfides such as polyphenylene sulfide (PPS) may be used as high-performance plastics. Most of the high-performance plastics listed exhibit better resistance properties than technical plastics not only in terms of maximum temperature, but also with regard to minimum temperature, chemical resistance and/or pressure.

Additionally, polyphthalam ides (PPA), particularly high temperature polyphthalamides (HT-PPA), may be used as polymer materials. This is a group of polyamides that are prepared from the aromatic monomers terephthalic and isophthalic acid (HOOC—C₆H₄-COOH) and hexamethylene diamine (6 C atoms) and are the most resistant of the polyamides to high temperatures. Their long term heat resistance is in the range from about 150° C. up to a maximum of 160° C. Their moisture absorption is in the range from about 0.1 percent to 0.3 percent. One representative of this polyamide group, which is designated PA Z1 Z2, is PA 612, and is commercially available under the name VESTAMID® D from Evonik Industries AG, for example. This polyamide is the product of polycondensation from 1,6-hexamethylene diamine and 1,12-dodecanedioic acid. Although the concentration of carbonamide groups in PA 612 is slightly higher than in polyamide 12, is it still considerably lower than in PA 6 or PA 66. Its long term heat resistance is in the range from about 130° C. to 140° C. According to the invention, the term High Performance Polymer is also used to refer to polymers that have a long term heat resistance in the range from about 130° C. to 140° C.

Of course, the media line may also have a multilayer structure, particularly an inner layer consisting a material with good resistance to a medium passing through the media line. Thermal braids made most particularly from fluoropolymers, particularly perfluoro-ethylene-propylene plastic (FEP), ethylene tetrafluoroethylene (ETFE), polytetrafluoroethylene (PTFE) or polyphenylene sulfide (PTF), are advantageously used as sheathing for the heating element, to ensure that an outer insulating material of the heating element positioned close to a heat source, particularly in the proximity of the exhaust system or a vehicle engine, is not damaged by the high temperatures. Particularly if insulating materials of such kind are used as sheathing for the heating element, it would not be possible to create a sealed crimped closure, since sealing materials bond poorly if at all with such substances. Consequently, for this reason also it is very advantageous to provide only one heating element, which extends along the heatable media line without crimping, that is to say without connection points.

When a clearance is present between the closed end of the looped heating element and the line connector or the sheathing or outer encapsulation thereof that is not heated by the heating element, at least one seal may be provided between an enclosing pipe encircling the media line and the outside of the media line in the proximity of the sheath system for insulating enclosure of the line connector and the tubular or hose-like media line. The seal may serve to prevent water from getting into the sheath system, particularly an enclosing pipe encircling the media line, and collecting there. This would prevent the media line from thawing at localised sites, because it would neutralise the insulating effect otherwise provided at such sites by the sheath system such as the enclosing pipe, and the mass of ice that would have to be thawed would be too great. Such a sealing arrangement on the typically smooth surface of the media line is much more feasible and more effective than attempting to seal an area of the heating elements extending over the outside of the media line.

In order to produce the heatable media line, the heating element is wound discontinuously, i.e., in a non-uniform manner around the longitudinal extension thereof. The heating element is formed into at least one loop, such that one closed end and two open ends are created. The closed end is arranged in the desired position along the media line and advantageously fastened to the media line by means of at least one fastening device. At least one reference mark may be made along the media line in advance or at the time to ensure that the closed end of the heating element that has been formed into at least one loop is correctly and precisely positioned. This mark may be made adjacent to a reference mark for arranging the line connector that is to be placed at this end of the media line.

The media line may be produced with or without one or more line connector(s) arranged at the ends thereof around which the heating element would be wound. The media line is most often connected to the line connector(s) by lasering, so in order to prevent the heating element from being damaged subsequently, after it has been finally put in position, it is proven advantageous to connect the media line to the one or more line connector(s) before the heating element is wound round them.

The heating element is advantageously arranged about the cross section of the media line, enclosing said media line symmetrically with the loop formed at the end thereof or with its two free heating element ends created by the formation of the loop, and in a cross sectional view of the media line the two free heating element ends or sections extend in opposite one another on the media line in the vicinity of the loop. Regarding the longitudinal extension of the heating element, this is advantageously folded asymmetrically to form the loop, that is to say the lengths of the ends are different so that the longer end, or the resulting longer heating element section, can be used for winding around the line connector that is to be arranged on the media line. In order the wind the heating element around the media line, the media line may for example be rotated with or without a line connectors attached to each end thereof, wherein the ends of the heating elements are subjected to a bias and the heating element is fed under tension and wound around the outside of the media line as the media line is pushed forward. The winding may be carried out one section at a time with different pitches so that the media line can be provided with various heat inputs. The process of discontinuous winding and particularly the creation of a difference in the end lengths at the open or free ends of the heating element, makes it possible to arrange the heating element on the heatable media line according to the requirements of the application. Waste due to excess or unused heating element may thus advantageously be avoided.

After the heating element has been arranged on the media line, it may be secured in place on the outside of the media line for example by winding an adhesive tape, fabric tape or duct tape around it. In order to connect it to a power supply, electric supply leads that are connectible or connected to an electric plug or the electric plug itself may be secured to the open ends of the heating element before or after it is wound round the heatable line connector.

Electric supply leads or a lead out of the heating element ends may be provided to afford a connection to an electric power supply in the area of the heatable line connector, but also along the longitudinal extension of the media line. The lead out of the heating element ends for connection to an electric plug or the attachment of electric supply leads that are connected to the ends of the heating elements is advantageously located at a distance from a line connector around which little or no heating element has been wound to allow it to be located close to a heat source. The arrangement of the electric supply leads or heating element ends for connection to an electric power supply in the area of the media line may help to minimise space requirement in the installation space of the heatable line connector, which is sometimes limited.

When creating a discontinuous winding or arranging the heating element on the heatable media line, the part of the heatable media line that is located in a hot or wind-protected region of the implementation sited will only be heated slightly, or not at all, by the heating element, that is to say little or no heating power or warmth will be introduced into the heatable media line by the heating element. In this context, the line connector that is located in the hot region is advantageously not heated at all, in other words, no heating element is wound around it. When the vehicle is in operation, the connector is warmed and kept sufficiently warm by its surroundings and/or its protected, possibly wind-protected arrangement, and the coupling of additional heat via the heating element might possibly result in overheating of the heatable media line and/or the line connector and of the heating element placed thereon. Medium in the hot region that has frozen while the vehicle was stationary may be thawed again quickly enough by the warmth of the surrounding area after the vehicle is started up, particularly by the heat generated by the engine, without the provision of a heating means via the heating element. Accordingly, only those sections of the heatable media line that are not located in the hot or protected area of the application site, particularly in a vehicle, are heated or warmed by the heating element. This effectively prevents the formation of hotspots in the hot or protected region. In addition, the potential exists to reduce costs due to the use of only a minimal quantity of heating element compared with other solutions of the prior art, in which multiple heating elements extend along the heatable media line, including the line connectors thereof.

### BRIEF DESCRIPTION OF THE DRAWINGS

In order to explain the invention in greater detail, it will be described in the following with reference to the drawing. In the drawing:

FIG. 1 shows a partial lateral cross section of a first embodiment or a prefabricated heatable media line with one unheated and one heated line connector attached to the end of the media line and a small unheated section of the media line,

FIG. 2 is a view of part of a lateral cross section of a second embodiment of a prefabricated heatable media line according to the invention with an unheated line connector attached to the end of the media line and having a sealed area inside an enclosing pipe that surrounds the media line,

FIG. 3 is a schematic diagram of a wiring arrangement according to the invention of a heating element extending over a subarea of a prefabricated heatable media line according to the invention, in combination with a second heating element extending over a heatable line connector arranged on the end of the media line,

FIGS. 4 to 7 show individual steps in the winding operation to create an arrangement of the heating element according to the invention along a heatable media line according to the invention,

FIG. 8 is a side view of a media line according to the invention wound with a discontinuously wound heating element,

FIG. 9 is a schematic diagram of a wiring arrangement according to the invention of a heating element of a heatable media line according to the invention, and

FIG. 10 is a schematic diagram of a wiring arrangement according to the invention of two consecutively arranged media lines with one unheated line connector arranged on the end thereof and one heated line connector arranged on the end thereof.

### DETAILED DESCRIPTION OF THE INVENTION

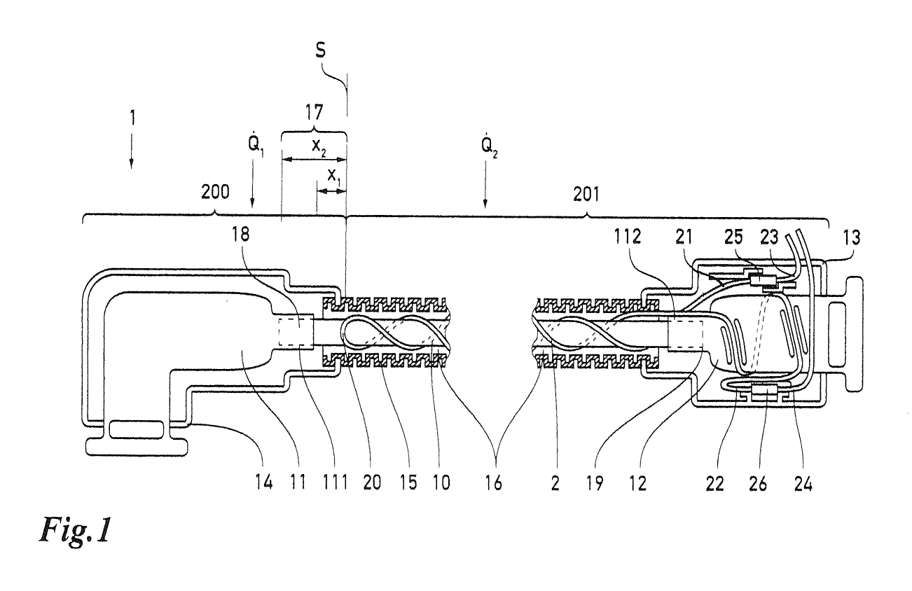

FIG. 1 shows a partial cross section of a first embodiment or a prefabricated heatable media line 1 according to the invention, comprising a tubular or hose-like media line 10 and two line connectors 11, 12 arranged on the ends thereof. IN the embodiment shown in FIG. 1, first line connector 11 has the form of an “angle connector”, while second line connector 12 is straight. Both line connectors 11, 12 may also be of straight or angled design, in particular first line connector 11 may also be a straight line connector and second line connector 12 may also be an angle connector.

A single heating element 2 extends along media line 10. It also extends over second line connector 12, with the result that said second connector is heatable. Heating element 2 is looped, so that it has one closed end 20 and two open ends 21, 22. The ends of the two open ends 21, 22 are connected to electric supply leads 23, 24 via crimp connections 25, 26. Crimp connections 25, 26 are arranged for protection inside an outer, insulating and protecting encapsulation 13 of second line connector 12. The two electric supply leads 23, 24 are extended out of encapsulation 13. They are furnished with an electric plug and may be connected to an electric power supply, though this is not shown in FIG. 1.

First line connector 11 is provided without a wound heating element and is also surrounded by an outer insulating and protective encapsulation 14. Media line 10 is also surrounded by an enclosing pipe 15, here in the form of a corrugated pipe. Encapsulations 13, 14 and enclosing pipe 15 together form an insulating sheath system. The air gap 16 formed between the sheath system and the two line connectors 11, 12 and media line 10 performs an insulating function by virtue of the air included therein. Moreover, heat can be transported within the sheath system to a certain degree via the air present therein when a part thereof is heated, for example by heating element 2, so that warmed air is also suppled to the area of first line connector 11 and the part of media line 10 that is not furnished with heating element 2.

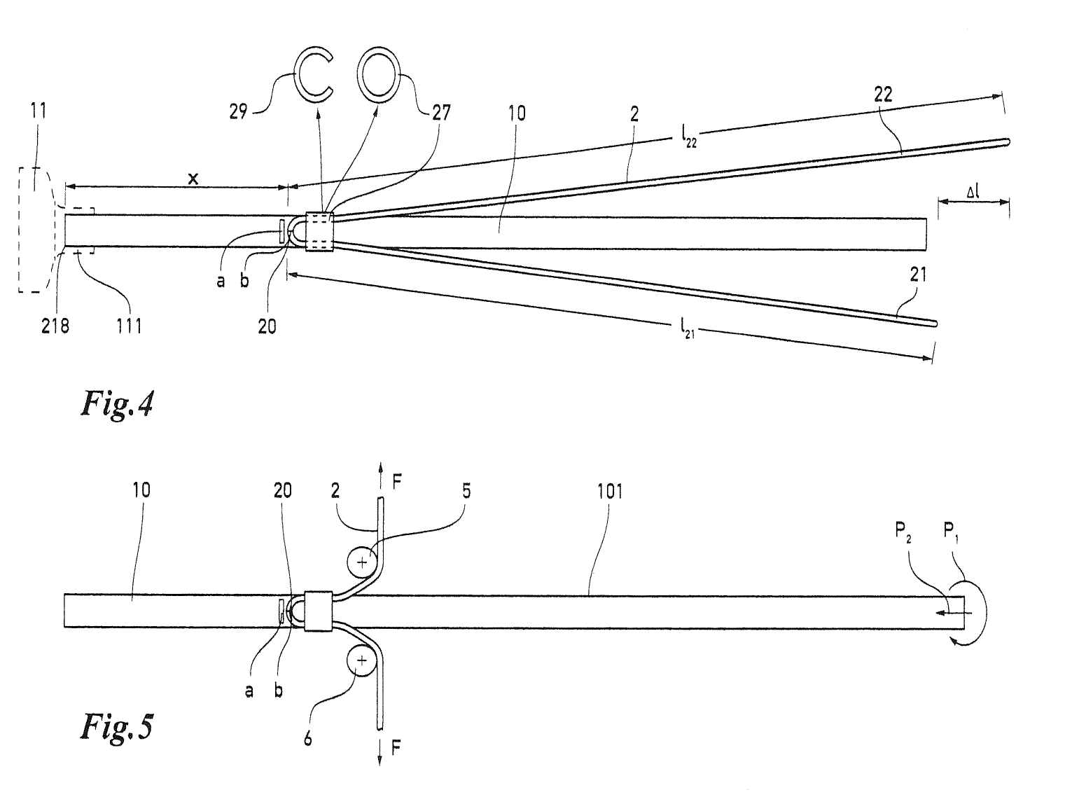

As may also be seen in FIG. 1, a length x₂ not only of first line connector 11, but also of a section 17 of media line 10 is free from the wound heating element 2. Closed end 20 of the heating element loop is located at this distance x₂ from the outer end of media line 10. A receiving section 111 of line connector 11 accommodates an end section 18 of media line 10, so that the unwound section 17 protrudes out of line connector 11 by a length x₁, wherein x₁<x₂. This is also evident in FIG. 1. Closed end 20 of the heating element is fastened to media line 10, by means of a clip, adhesive tape or hooked or any other kind of fastening element. In FIGS. 4 to 8 a tape-like fastening element 27 is indicated for exemplary purposes. The provision of the fastening device ensures that closed end 20 of the heating element loop does not migrate along media line 10 but remains securely in position at the desired site.

As is also indicated in FIG. 1, but may also be seen in FIGS. 4, 6, 7, 8 and 9, free or open heating element ends 21, 22 are arranged to protrude beyond the outer end 19 of media line 10 by different lengths, and consequently a length difference of the one free or open heating element end remains so that is may be attached to second line connector 12, which is heatable by means of heating element 2. Alternatively, both heating element ends 21, 22 may be cut to different sizes, or optionally both heating elements 21, 22 may be attached to second heatable line connector 12.

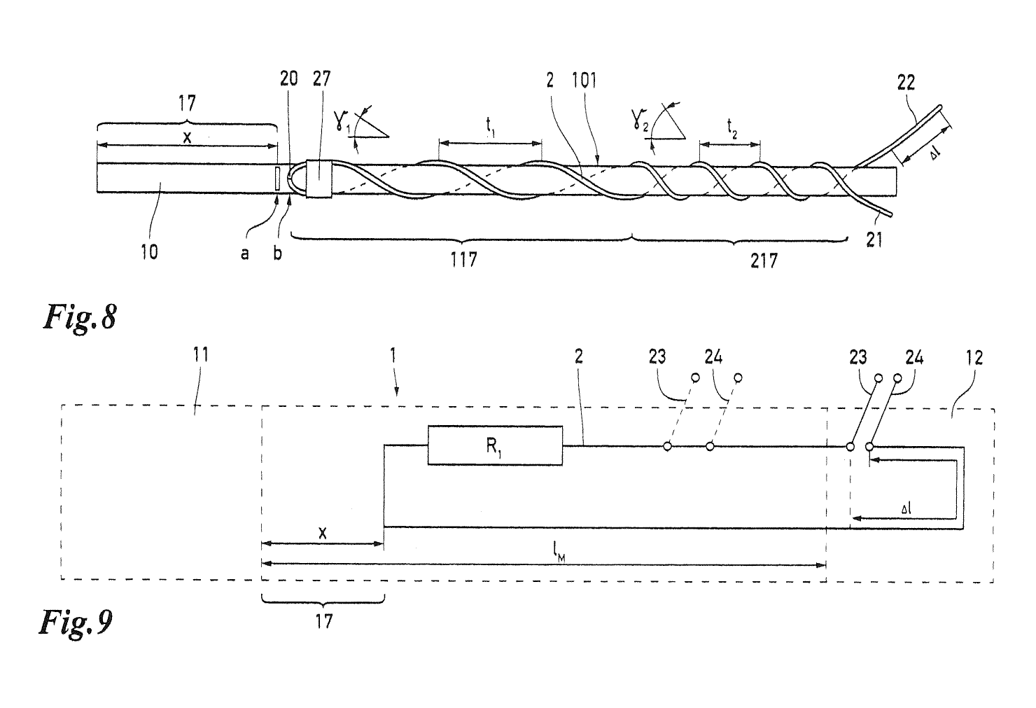

As is further indicated in FIG. 1, provision is made for different heat inputs in the individual sections of the prefabricated heatable media line, for example the heat input with value Q₁ that is applied to line connector 11 (section 200) in the absence of a wound segment of heating element 2 (e.g., due to the waste heat from a vehicle engine) and the heat input with value Q₂ that is applied to section 201 of the remaining part of media line 10 and line connector 12, which is heatable by heating element 2 (by heating element 2 arranged there). Depending on the amount of heating element arranged in the area of second line connector 12, a heat quantity differing from Q₂ may be coupled there. It a least two different heat quantities Q₁ and Q₂ are provided, a system boundary S may be defined in the transition zone therebetween, when a third heat quantity is coupled, then two system boundaries may be defined. In the embodiment of heatable media line 1 shown in FIG. 1, system boundary S is located in the area of the attachment point of the closed end of the heating element loop. Depending on the nature of the winding, that is to say the quantity of heating element used per unit length of media line 10 and/or line connector 12, other heat quantities may also be coupled, and accordingly more system boundaries defined, as may be seen in FIG. 8, for example. In FIG. 8, no heating element 2 is wound around section 17 of media line 10 for a length x, and in the section 117 adjacent to said section 17 the winding is provided with a pitch γ₁, that is to say a distance t₁ between the individual coils of the heating elements, and in a section 217 adjacent thereto, the winding is realised with pitch γ₂, corresponding to a distance t₂ between the coils of the heating element, wherein a greater quantity of heat is coupled in section 217 than in section 117, and a greater quantity of heat is coupled in section 117 than in section 17.

As may be further deduced from FIG. 8, in this case closed end 20 of heating element 2 is secured by applying tape-like fastening element 27 to the outside 101 of media line 10. A positioning aid or reference marking a is made on media line 10, and a positioning aid or reference marking b is made on the heating element to ensure that closed end 20 of heating element 2 can be attached correctly to media line 10. The two markings a and b are positioned side by side, as shown in FIG. 8. Optionally, they may also be positioned one on top of the other. The nature of markings a and b may be chosen according the material used for media line 10 and heating element 2 or the optionally provided insulating sheathing in which it is enclosed. Markings a, b are important for ensuring the reproducibly precise positioning of heating element 2 and closed end 20 thereof.

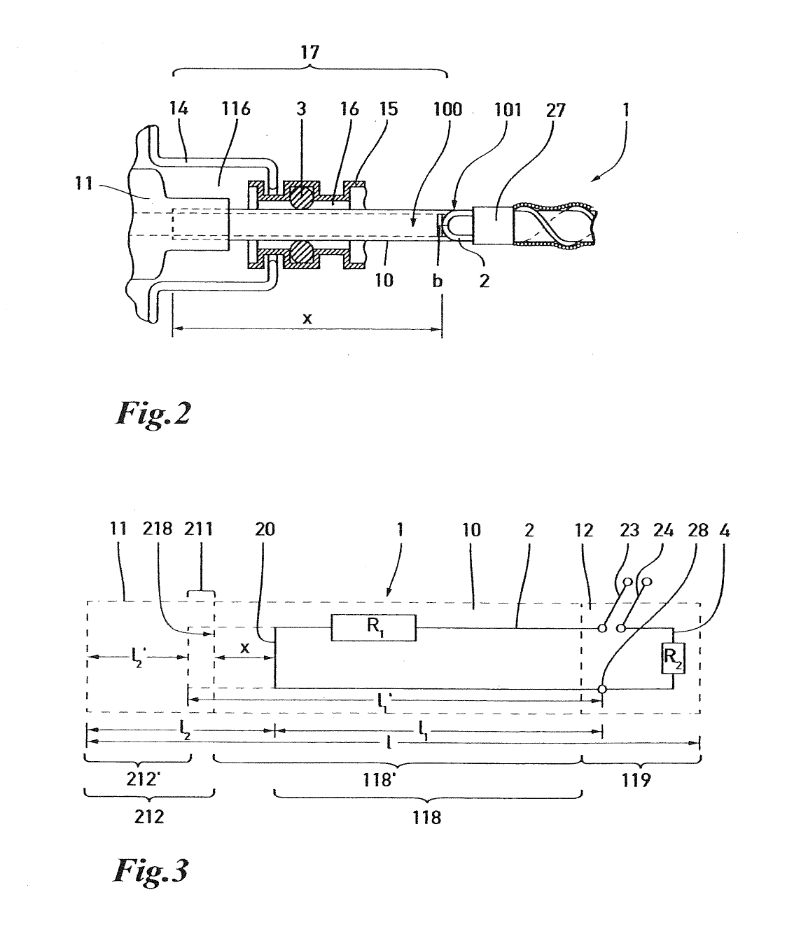

FIG. 2 shows an embodiment of prefabricated heatable media line 1 that differs from the variant of FIG. 1, and in which the section 17 on which no heating element 2 has been wound has a length x, and is thus longer than the section shown in FIG. 1, in other words the attachment point (marking b) of closed end 20 of heating element 2 is located farther from the end of media line 10. Another difference from the prefabricated heatable media line variant shown in FIG. 1 is that in the embodiment of FIG. 2 a sealing element 3 is provided inside enclosing pipe 15, embodied here as a corrugated pipe, to seal air gap 16 inside the enclosing pipe off from air gap 116 in encapsulation 14. Sealing element 3 serves to prevent water from penetrating and collecting inside enclosing pipe 15. It has proven advantageous to arrange sealing element 3 outside the attachment area of heating element 2, since a smooth surface is available for sealing in this area of the media line 10, which is designed as a smooth pipe, unlike the area in which heating element 2 is arranged helically around the outside 101 of media line 10. It would be more difficult to provide a sealing element in this area. The fact of positioning heating element 2 at a distance from sealing element 3 also makes additional protection for heating element 2, because it is also positioned farther from sealing element 3 and thus also arranged at a distance from the element in contact with any water that has penetrated on the opposite side of sealing element 3 to heating element 2.

FIG. 3 shows a schematic diagram of the prefabricated heatable media line in which, similarly to the embodiment of FIG. 9, closed end 20 of heating element 2 is arranged at a distance x from end 218 of media line 10. Another embodiment variant is indicated with dashed lines, in which heating element 2 also extends slightly over a section 211 of first line connector 11. Again, only a single heating element 2 is provided for winding round media line 10, and the open ends 21, 22 thereof extend as far as second line connector 12. In the variant according to FIG. 3, this is particularly wound with a second heating element 4 having a resistor R₂. Heating element 2 is shown as having a resistor R₁. In general, however, only the one heating element 2 can be used to wind around and thus also heat heatable line connector 12, as is also shown in the previous figures. The important point is that there are no connection or crimping points at all located in the area of heatable line connector 11 around which little or no heating element 2 is to be wound. This line connector 11 which is to be exposed to little or no heating is arranged for example in a region of a motor vehicle that is strictly temperature controlled and/or protected against the effect of cold, such as in the area of a heat source for example an engine or exhaust system, or a metering/injection point. Consequently, there is little or no need for additional heating means for prefabricated heatable media line 1 in this area of first line connector 11 due to the abundant available heat, and heating element 2 does not have to be provided here. Advantageously, no heating means at all is provided by heating element 2, as has already been indicated in the preceding FIGS. 1 and 2. If additional heating means were provided in the form of heating element 2, this section of the prefabricated heatable media line might overheat and suffer damage. Therefore, only the sections of prefabricated heatable media line 1 that are located in a colder or unprotected region of a vehicle for example are heated by heating element 2, in this case sections 118 of media line 10 and 119 of second line connector 12, in the variant indicated by dashed lines sections 118′ of media line 10 and 211 of first line connector 11. Section 212 of first line connector 11, and 212′ in the variant of the dashed outline, are unheated. Thus, means for heating or warming by heating element 2 is only provided in the sections of prefabricated heatable media line 1 where it is required. This in turn helps to lower costs in terms of the heating element to be provided and in terms of the total heatable media line.

In the variant of the prefabricated heatable media line 1 shown in FIG. 3, electric supply leads 23, 24 are attached in the area of second line connectors 12, as well as a connection point or crimping point 28 between the two heating elements 2, 4.

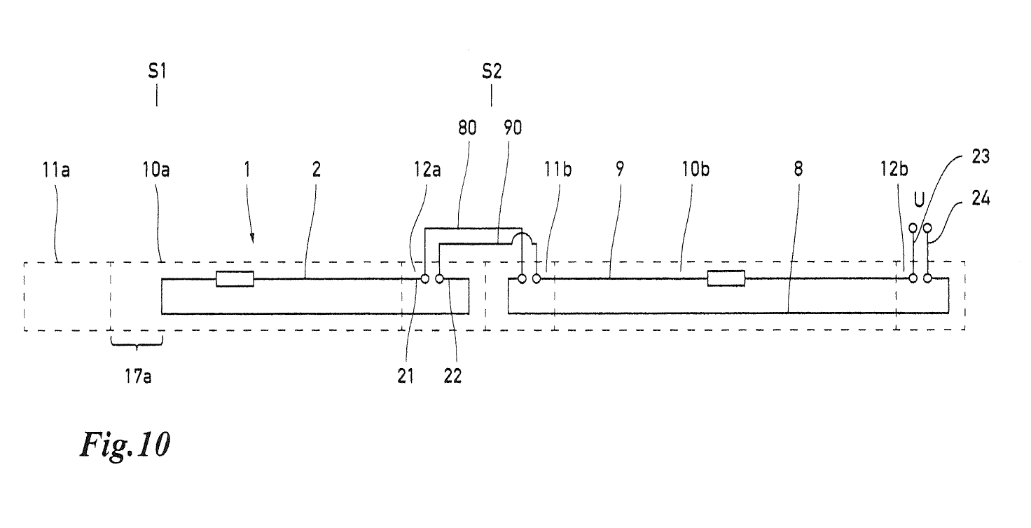

In FIG. 3, the total length of prefabricated heatable media line 1 is represented by I, wherein length I₂ of the section 212 that is not heatable or heated by heating element 2, otherwise length I₂′ of the section 212′ that is not heatable or heated by heating element 2, is relatively small compared with the lengths I₁ and I₁′ that are heatable by heating element 2. Length I₂, also I₂′, may be less than 20% as long as total length I, for example. If several media lines 10 are arranged consecutively, as indicated in FIG. 10, the length on which heating element 2 is not provided may be less than 5 to 10% of the total length I of the prefabricated heatable media line.

FIGS. 4 to 7 show the individual steps of the method for producing a prefabricated heatable media line 1 according to the invention, such as is represented in FIG. 1, for example. As indicated in FIG. 4, media line 10 may be connected to first line connector 11 and only wound with heating element 2 afterwards. It is also possible for media line 10 to be furnished with heating element 2 without previously attaching line connector 11, and optionally also without attaching heating element 2 to line connector 12 particularly by winding. The winding may be carried out selectively, in particular with different pitches. To carry out the winding, first heating element 2 is doubled over to form a loop, creating closed end 20 and the two open ends 21, 22. As shown in FIG. 4, closed end 20 is not positioned centrally between the two open ends 21, 22, but asymmetrically, so that a longer section having length I₂₂ and a shorter section having length I₂₁ and length differential Δl remain. This is created in FIG. 4. Closed end 20 is fastened to the outside of media line 10 via tape-like fastening element 27. A clip-like fastening element, identified with reference numeral 29 in FIG. 4, may be provided instead of tape-like fastening element 27. It is also possible to provide a hooked fastening elements, which hooks into closed end 20 of heating element 2.

After closed end 20 is fastened to the desired point at a distance x from first end 218 of media line 10, winding commences with a bias force F being applied to both ends of heating element 2. Media line 10 is also subjected to a rotating motion, as indicated by arrow P₁ in FIG. 5. As indicated in FIG. 5, guide rollers 5, 6 may be provided to bias both parts of the heating element. These are arranged for example in a corresponding mounting of a winding device for the media line (not shown). In the variant shown in FIG. 5, media line 10 is not only rotated, but also pushed in the direction of end 218 thereof between rollers 5, 6 with a predefinable pushing force. This is indicated by arrow P₂. The heating element ends are thus advanced correspondingly under a bias force. This ensures that tension is applied evenly as heating element 2 is arranged on outside 101 of media line 10.

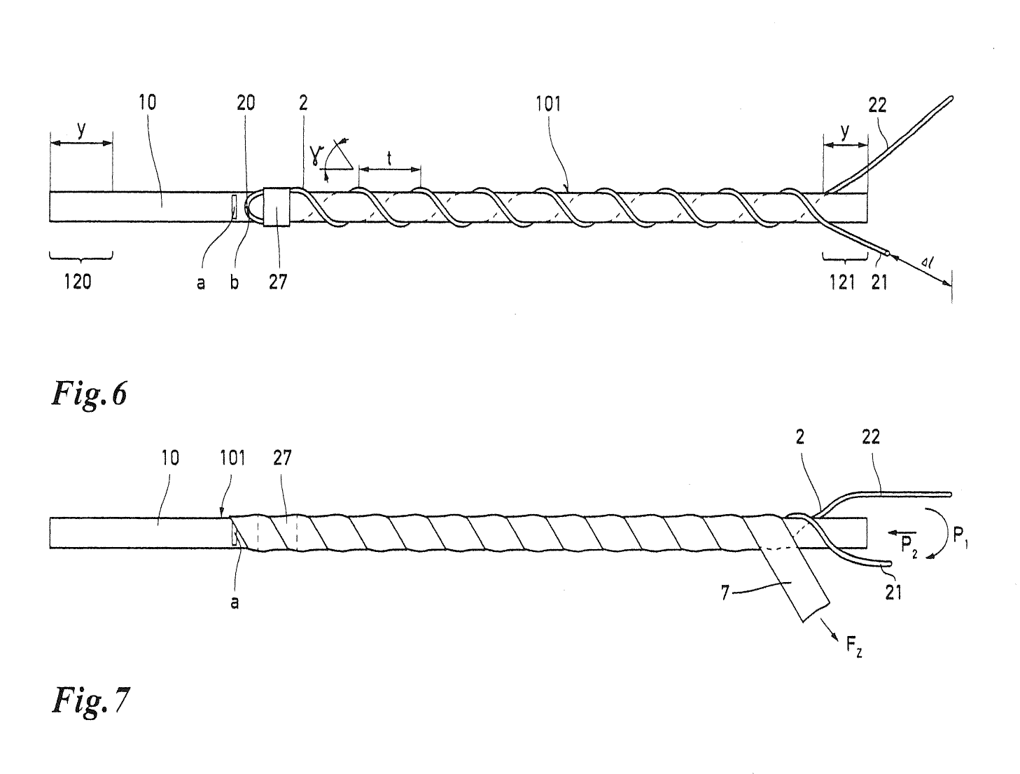

FIG. 6 shows media line 10 with heating element 2 wound in place. In this case, heating element 2 is arranged with a pitch γ and correspondingly a distance t between the individual coils of the heating element winding on the outside 101 of media line 10. Free ends 120, 121 are left at both ends of media line 10 to enable connection with the two line connectors 11, 12, each of which has a length y in the embodiment shown here. With this length y, media line 10 is inserted in mounting section 111 or 112 of the two line connectors 11, 12, as indicated in FIG. 4 and particularly in FIG. 1.

It may be seen in FIG. 7 that for example an adhesive, fabric tape or duct tape 7 may be used to secure the position of heating element 2 arranged on the outside 101 of media line 10. This is advantageously also put in place on the outside 101 of media line 10 and the heating element 2 wound around it 2 with the application of a tensile force F_{z}. As in FIG. 7, here too this may be carried out by rotating and simultaneously advancing the media line 10 (see arrows P₁ and P₂), thus ensuring that strip 7 can be applied evenly, with even application of a tensile force F_{z}.

FIG. 9 shows a schematic diagram of the various attachment options of electric supply leads 23, 24 along heating element 2 and prefabricated heatable media line 1. Once again, in the variant of medial line 10 furnished with two line connectors 11, 12 at the ends thereof indicated in outline by the dashed lines in FIG. 9, heating element 2 is not wound round a section 17 of the media line with length x, nor around first line connector 11. Heating element 2 is only provided on, particularly wound around, second line connector 12, wherein, as in the sketch shown in FIG. 9, end 22 of heating element 2 is longer than the other end 21 by length Δl, thereby making it possible to use this length Δl of the heating element to wind around line connector 12. The length of media line 10 is indicated in this case with I_{M}. The two electric supply leads 23, 24 may also be arranged in the area of second line connector 12 or alternatively also along the longitudinal extension of media line 10. The media line is represented in outline by dashed lines in FIG. 9. In order to prevent one or more sections of prefabricated heatable media line 1 from overheating when a part of said prefabricated heatable media line 1 has been installed in the proximity of a heat source or in an area protected from the effects of cold, of a vehicle for example, heating element 2 is also not wound around section 17 of media line 10 and first line connector 11 in the heatable media line 1 outlined in FIG. 9. Instead of providing electric supply leads 23, 24, the two open ends 21, 22 of heating element 2 may simply be equipped with an electric plug and connected to an electric power source.

FIG. 10 shows a connection in series of two media lines 10a, 10b, wherein a first line connector 11a, 11b and a second line connector 12a, 12b are provided on the respective ends of the two media lines 10a, 10b to connect them, wherein media lines 10a, 10b are connected to each other via line connectors 12a and 11 b. Heating element 2 of first media line 10a extends over a partial area of media line 10a and line connector 12a. Heating element 2 is not wound round line connector 11 a or section 17a of first media line 10a. First media line 10a with the two line connectors 11a, 12a on the ends thereof is thus equivalent in principle to the variant of heatable media line 10 shown in FIG. 9. Line connector 11b is connected to line connector 12a. A heating element 8 extends along first and second line connectors 11b, 12b of second media line 10b. In addition, a further heating element 9 is provided, extending substantially along second media line 10b. These two heating elements 8, 9 are connected to heating element 2 via connecting lines 80, 90. Thus, instead of connecting the two open ends 21, 22 of heating elements 2 to the electric supply leads 23, 24 as shown in FIG. 9, in FIG. 10 the two connection lines 80, 90 are connected to ends 21, 22 of heating element 2, particularly by crimping. A connection to an electric power supply, indicated by voltage U, is possible via the two electric supply leads 23, 24, which in the variant of FIG. 10 are connected to the two heating elements 8, 9 in the area of second line connector 12b.

Line connector 11a and section 17a of first media line 10a are particularly arranged in a hot region, for example in the proximity of a metered dispensing output or point, and/or close to the engine or exhaust system in a vehicle, whereas line connector 12b is arranged in the cold region of a vehicle, particularly in proximity to a fuel tank. In particular, the voltage supply is also in this region, that is to say in the cold region or close to a fuel tank. As shown in FIG. 10, instead of just one heating element, multiple heating elements may be arranged in the area of second media line 10b with line connecters 11b, 12b attached to the ends thereof. In principle, however, it is also possible to make provision for arranging only a single heating element, which is created along the entire heatable media line produced by connecting multiple media lines 10a, 10b etc., one after the other, and only to provide connection to a power supply at the end thereof, that is to say in the area of the one of the media line sections, particularly by attaching electric supply leads 23, 24 there. Besides the second media line 10b with the assigned line connectors 11b, 12b attached to the ends thereof, further media lines or media line segments may also be coupled therewith, still other media lines or media line segments may also be attached, in particular also to enable variable quantities of heat to be input optimally over the longitudinal extension of completed prefabricated heatable media line 1, and to enable it to operate more cheaply in terms of the materials of the respective media line with the line connectors attached to the ends thereof, since high temperature plastics that are provided in the hot region of the prefabricated heatable media line are significantly more expensive than standard plastics, which are usable for the cold region of prefabricated heatable media line 1.

In the variant of FIG. 10, two system boundaries for heat input purposes are provided, specifically a first system boundary S1, which sets unheated line connector 11a and section 17a of first media line 10a from the rest of media line 10a with the attached line connector 12a, and a second system boundary S2 in the transition zone between line connector 12a and line connector 11b. In addition, at least one further system boundary created by differentiated heat introduction may be provided.

Thus, a part of the respective media line 10, 10a and a part of the first line connector 11 or 11a remains unheated in each of the variants described in the preceding. This lends itself particularly well to the situation in which areas of heatable media line 1 are exposed to intensive introduction of heat from the surrounding area, particularly a section of media line 1 arranged close to the engine in a vehicle, which is unheated because it is exposed intensive heat introduction from the surrounding area via the external heat source, so that it does not need to be heated by heating element 2. The provision of only one heating element 2, extending along media line, optionally also over a small section of first line connector 11 or 11a, which section however is not furnished with crimping points or connection points, has proven particularly advantageous for preventing failure of the heating element due to damage to the connection and or crimping points. In the region that is heated by a heat source present at the site of use, particularly of a vehicle, it is sufficient to provide little or even no heating means, wherein a heating means by air circulation within the sheath systems consisting of enclosing pipe 15 and encapsulation 13, 14 may already be sufficient. Heat sensitive components and connection points in the hot region that might be vulnerable to damage are advantageously avoided, thereby also ensuring the durability of the prefabricated heatable media line and reducing the cost of production thereof. In the hot region, which represents thermal stress for heatable media line 1, heat resistant materials, for instance fluoropolymers, e.g., FEP, ETPE, PTFE or PPS, are advantageously used both for media line 10 or 10a and for the first line connector 11 or 11a, and also for the braid sheathing or heating element sheathing/heating element insulation. When fluoropolymers are used, it is difficult to create a material bond to form a protective sheathing, for example with a shrink-on tube or overmoulding, because materials adhere poorly to fluoropolymers, and the omission of crimping points is advantageous for this reason too.

Besides the variants of prefabricated heatable media lines and production methods as well as the possible uses thereof, particularly in a vehicle, described in the preceding text and illustrated in the figures, many other variants may also be provided, in which the heat input into such a media line may be differentiated over the entire longitudinal extension thereof, wherein the one electric heating element is arranged and/or constructed over the longitudinal extension of the media line in such manner that at least two different heatable or warm sections are or can be created along the length of the prefabricated heatable media line.

### LIST OF REFERENCE SIGNS

1 Prefabricated heatable media line

2 Heating element

3 Sealing element

4 Second heating element

5 Roller

6 Roller

7 Adhesive, fabric, duct tape

8 Heating element

9 Heating element

10 Tubular or hose-like media line

10a First media line

10b Second media line

11 First line connector

11a First line connector

11b First line connector

12 Second line connector

12a Second line connector

12b Second line connector

13 Encapsulation

14 Encapsulation

15 Enclosing pipe

16 Air gap

17 Section

17a Section

18 First end section of 10

19 Second end of 10

20 Closed end

21 Open end

22 Open end

23 Electric supply lead

24 Electric supply lead

25 Crimp connection

26 Crimp connection

27 Tape-like fastening element

28 Crimp connection

29 Clip-like fastening element

80 Connection line

90 Connection line

100 Interior cavity

101 Outside

111 Mounting section

112 Mounting section

116 Air gap

117 Section

118 Section

118′ Section

119 Section

120 Free end

121 Free end

200 Section

201 Section

211 Section

212 Section

212′ Section

217 Section

218 Outer end of 10

x Distance

x₁ Distance

x₂ Distance

y Length of 120 or 121

γ Pitch

γ₁ Pitch

γ₂ Pitch

t Distance

t₁ Distance between individual coils of the heating element

t₂ Distance between individual coils of the heating element

a Marking

b Marking

R₁ Resistor, heating element 2

R₂ Resistor, heating element 4

I Total length of 1

I₁ Heatable length

I₁′ Heatable length

I₂ Length not heatable by heating element 2

I₂′ Length not heatable by heating element

I_{M} Length of media line 10

F Force

P₁ Arrow

P₂ Arrow

F_{z} Tensile force

S System boundary

S1 First system boundary

S2 Second system boundary

What is claimed is:

1. A prefabricated heatable media line, comprising: at least one media line with two connection ends (120, 121), at least one line connector, which is connected to one of the connection ends of the media line, and comprising an electric heating element (2) paired with the media line,
wherein a single heating element paired with the media line (10, 10a) is arranged and/or formed over a longitudinal extension of the prefabricated heatable media line such that a heat input (Q₁, Q₂) into the media line is produced, said heat input being differentiated over the longitudinal extension of the prefabricated heatable media line, wherein at least two differently heatable or heated sections are produced or can be produced along the prefabricated heatable media line.

2. The prefabricated heatable media line according to claim 1, wherein the at least two differently heatable or heated sections are provided along the media line and/or along the line connector and/or in a transition zone from the media line to one of the line connectors, particularly that the media line comprises at least a first heatable or heated section, and the line connector comprises at least a second section that is less heated or heatable than said first section.

3. The prefabricated heatable media line according to claim 1, wherein a discontinuous winding of a winding is provided over the longitudinal extension of said heatable media line, with a continuous pitch (γ, γ₁, γ₂) of the heating element within a heatable section.

4. The prefabricated heatable media line according to claim 1, wherein at least one section of the heatable media line receives no heat input from the electric heating element, in particular that the heating element is not wound round a line connector of the heatable media line.

5. The prefabricated heatable media line according to claim 1, wherein multiple media lines (10a, 10b) or media line sections are connected consecutively, wherein the at least one heating element of at least one further media line is connected in series to the heating element of the first media line.

6. The prefabricated heatable media line according to claim 1, the wherein the length (x, x₁, x₂, I₂) of the sections that are free from heat input from the heating element is small compared with a length (I₁) of the heatable media line that is furnished with the heating element, particularly less than 20% of the total length (I) of the heatable media line.

7. The prefabricated heatable media line according to claim 6, wherein when multiple consecutively connected media lines are provided, the length (x, x₁, x₂, I₂) of the sections that are free from heat input from the heating element is equal to 5 to 10% of the total length (I) of the heatable media line.

8. The prefabricated heatable media line according to claim 1, wherein the heating element is formed into at least one loop having one closed end and two open ends, and is attached with the closed end thereof to the media line outside of the line connector that is not to be heated by the heating element.

9. The prefabricated heatable media line according to claim 8, wherein the closed end of the heating element is fastened to the media line by at least one fastening device, particularly by a clip and/or a bonding device and/or an adhesive, fabric or duct tape and/or a hooked fastening device.

10. The prefabricated heatable media line according to claim 8, wherein when two line connectors attached to the end of media line are provided, the heatable line connector is furnished, particularly wound, with only one of the two heating element end sections.

11. The prefabricated heatable media line according to claim 1, wherein a sheath system is provided that encloses the prefabricated heatable media line and enables air to circulate in an intermediate space between an outside of the heatable media line and an inside of the sheath system so that heat can be exchanged between at least one heatable or heated section of the heatable media line and at least one section that is relatively colder than said first section.

12. A method for using a prefabricated heatable media line according to claim 1, comprising the steps of: arranging at least one section of the prefabricated heatable media line in a surrounding area that is heatable or heated or protected against the cold, and at least one section in a relatively colder surrounding area, and the heating element is arranged along the heatable media line such that the at least one section of the heatable media line that is arranged in the surrounding area that is heatable, heated or protected against the cold is not heated or heatable at all, or less strongly heated or heatable than the at least one other section thereof.

13. A vehicle, with at least one heatable media line according to claims 1, wherein at least one section of the heatable media line is arranged in an area of the vehicle that is heatable or heated or protected against the cold, and at least one section is arranged in an area of the vehicle that is relatively cooler, wherein the media line is provided with only a single heating element, and the heating element is arranged along the heatable media line in such manner that the at least one section of the heatable media line that is arranged in the area of the vehicle that is heatable or heated or protected against the cold is not heated or heatable at all, or less strongly heated or heatable than the at least one other section thereof.

14. The vehicle according to claim 13, wherein a line connector of the heatable media line arranged in the proximity of a heat source is not wound with the heating element.

15. The vehicle according to claim 13, wherein the section of the heating element that is arranged in the proximity of an area that is heatable or heated or protected against cold does not have any connection points.

16. The vehicle according to claim 13, wherein an electric connecting section of the heating element, particularly electric supply leads of the heating element, is/are arranged at a distance from the line connector that is arranged in the area that is heatable or heated or protected from cold.

17. A method for preparing a heatable media line according to claim 1, wherein the heating element is wound round the heatable media line discontinuously over the longitudinal extension thereof.

18. The method according to claim 17, wherein sections of the heatable media line are wound with a continuous pitch (γ, γ₁, γ₂).

19. The method according to claim 17, wherein the heating element is wound onto the media line selectively, and/or that the heating element is applied selectively to the media line and/or to a line connector that is connected to the end thereof.
